(19) United States
(12) Patent Application Publication
(10) Pub. No.: US 2015/0199476 A1
(43) Pub. Date: Jul. 16, 2015

(54) METHOD OF ANALYZING GENOME BY GENOME ANALYZING DEVICE

(71) Applicant: Electronics and Telecommunications Research Institute, Daejeon (KR)

(72) Inventors: Minho KIM, Daejeon (KR); Dae Hee KIM, Daejeon (KR); Myung-eun LIM, Daejeon (KR); Ho-Youl JUNG, Daejeon (KR)

(21) Appl. No.: 14/597,052

(22) Filed: Jan. 14, 2015

(30) Foreign Application Priority Data
Jan. 16, 2014 (KR) 10-2014-0005437
Nov. 14, 2014 (KR) 10-2014-0158688

(51) Int. Cl. G06F 19/22

(52) U.S. Cl. CPC G06F 19/22

(57) ABSTRACT

Provided is a method for analyzing a genome by a genome analyzing device. The method of analyzing a genome of the present invention includes: reading sequencing data of the genome from a storage device; selecting a position to be analyzed among positions corresponding to the sequencing data; and determining a base type at the selected position by using base types and quality values of bases corresponding to the selected position among the sequencing data.

### CROSS-REFERENCE TO RELATED APPLICATIONS

This U.S. non-provisional patent application claims priority under 35 U.S.C. §119 of Korean Patent Application Nos. 10-2014-0005437, filed on Jan. 16, 2014, and 10-2014-0158688, filed on Nov. 14, 2014, the entire contents of which are hereby incorporated by reference.

### BACKGROUND OF THE INVENTION

The present invention disclosed herein relates to a method of analyzing a genome by a genome analyzing device.

Genome analyzing technique includes sequencing for amplifying and dividing a genome to a plurality of fragments and an operation for determining genotypes from sequencing data.

A method of determining a genotype is based on a posteriori probability. For calculating a posteriori probability, a priori probability, which is determined by a reference sequence, is used. For instance, a priori probability is determined by using a haplotype of a reference sequence corresponding to a position having a genotype to be determined. For instance, in the case where a haplotype of a reference sequence at a certain position is cytosine, a priori probability of cytosine is used to calculate a posteriori probability. However, the purpose of the genomic analysis is not determining a genotype similar to or the same as the reference sequence, but identifying a genotype of a genome which is a subject of analysis. Thus, the analyzing result based on typical a posteriori probability may have an inappropriate accuracy for determining a genotype type of a genome to be analyzed.

In addition, for identifying a genotype based on a posteriori probability, likelihood for calculating a posteriori probability should be calculated. Likelihood is calculated from whole sequencing data, and thus the sequencing data should be read for calculating likelihood. In other word, for identifying a genotype typically based on a posteriori probability, there is a limitation in which identification time of a genotype become longer, since sequencing data is read for calculating likelihood and then sequencing data is read again for identifying the genotype.

### SUMMARY OF THE INVENTION

The present invention provides a method of analyzing a genome by a genome analyzing device having improved accuracy and improved calculation speed.

Embodiments of the present invention provide a method for analyzing a genome by a genome analyzing device, the method including: reading, by the genome analyzing device, sequencing data of a genome from a storage device; and determining, by the genome analyzing device, a genotype at the selected position by using quality values and base types (which are adenine, guanine, cytosine, and thiamine) of bases corresponding to the selected position among the sequencing data.

In some embodiment, the determining of the genotype at the selected position may include: calculating probabilities of accuracy and probabilities of error of the base types of the bases corresponding to the selected position, by using the quality values.

In still other embodiments, the determining of the genotype at the selected position may further include: selecting a genotype(s) which will be subjected to perform probability calculation among candidate genotypes at the selected position; and calculating a probability of the selected genotype by using probabilities of accuracy of bases having base types corresponding to the selected genotype and probabilities of error of bases having base types which do not correspond to the selected genotype, among base types of the bases corresponding to the selected position.

In even other embodiments, the calculating of the probability of the selected genotype may include: when the selected genotype is a homogenous genotype, multiplying probabilities of accuracy of bases corresponding to the base type of the selected genotype by probabilities of error of bases which do not correspond to base type of the selected genotype among the bases of the selected position.

In yet other embodiments, the calculating of the probability of the selected genotype may include: when the selected genotype is a heterogeneous genotype, determining a ratio between a first base type and a second base type of the selected genotype, selecting first bases corresponding to the first base type and second bases corresponding to the second base type among the bases at the selected position according to the determined ratio, and multiplying probabilities of accuracy of the selected first and second bases by probabilities of error of unselected bases.

In further embodiments, the selecting of the first bases corresponding to the first base type and the second bases corresponding to the second base type among the bases at the selected position according to the determined ratio may include: dividing the number of bases corresponding to the selected position into a first value and a second value according to the determined ratio; selecting, as the first bases, bases corresponding to the first base type when the number of bases corresponding to the first base type is not greater than the first value, and selecting, as the first bases, bases as much as the first value among bases corresponding to the first base type when the number of bases corresponding to the first base type is greater than the first value; and selecting, as the second bases, bases corresponding to the second base type when the number of bases corresponding to the second base type is not greater than the second value, and selecting, as the second bases, bases as much as the second value among bases corresponding to the second base type when the number of bases corresponding to the second base type is greater than the second value.

In still further embodiments, when the number of the first bases is greater than the first value, bases having a relatively high quality value may be selected as the first bases.

In even further embodiments, the ratio may be adjusted

In yet further embodiments, the selecting of the genotype and the calculating of the probability of the selected genotype may be repetitively performed until the whole candidate genotypes are selected.

In much further embodiments, the determining of the genotype at the selected position may further include selecting a candidate genotype having the highest probability among the candidate genotypes as a genotype at the selected position.

In still much further embodiments, the determining of the genotype at the selected position may further include selecting the candidate genotypes.

In even much further embodiments, the determining of the candidate genotypes may include: detecting the base types of the bases of the selected position; and selecting, as the candidate genotypes, genotypes combined by the detected base types.

In yet much further embodiments, the selecting of the candidate genotypes may include: detecting base types of the bases of the selected position; selecting, as a first candidate base type, a maximum base type corresponding to the largest number of bases among the detected bases at the selected position; selecting, as a second candidate base type, the base type having the number of bases having a ratio equal to or greater than a threshold value with respect to the number of bases of the maximum base type at the selected position; and selecting, as the candidate genotypes, genotypes combined by the first candidate base type and the second candidate base type.

In still further embodiments, the selecting of the candidate genotypes may include: detecting base types of the bases of the selected position; selecting, as a first candidate base type, a base type in which a sum of quality values of bases is the highest among the detected base types at the selected position; selecting, as a second candidate base type, a base type in which a sum of quality values has a ratio equal to or more than a threshold value with respect to the sum of total quality values of the first candidate base type at the selected position; and selecting, as the candidate genotype, genotypes combined by the first candidate base type and the second candidate base type.

In even further embodiments, the selecting of the candidate genotypes may include: detecting base types of the bases at the selected position; selecting at least one base type in an order of the highest number of bases among the detected base types at the selected position; and selecting, as the candidate genotypes, genotypes combined by the at least one base type selected.

In yet further embodiments, the selecting of the candidate genotypes may include: detecting base types of the bases at the selected position; selecting at least one base type in an order of the highest sum of quality values of bases among the detected base types at the selected position; and selecting, as the candidate genotypes, genotypes combined by the at least one base type selected.

In much further embodiments, the selecting of the position and the determining of the genotype at the selected position may be repetitively performed until the base types at all positions of the genome corresponding to the sequencing data are determined.

In still much further embodiment, the method may further include validating the genotypes of the genome by comparing to the reference sequence.

In even much further embodiments, the reading of the sequencing data comprises reading sequencing data corresponding to one or more positions of the genome.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram showing a genome analyzing system 100 according to an embodiment of the present invention;

FIG. 2 is a flow chart showing a method of analyzing a genome according to an embodiment of the present invention;

FIG. 3 shows examples of bases corresponding to a position selected among sequencing data of a genome loaded on a memory;

FIG. 4 is a flow chart showing an example of a method for determining a genotype at the selected position;

FIG. 5 is a flow chart showing a method for selecting candidate genotypes according to a first embodiment of the present invention;

FIG. 6 is a flow chart showing a method for selecting candidate genotypes according to a second embodiment of the present invention;

FIG. 7 is a flow chart showing a method for selecting candidate genotypes according to a third embodiment of the present invention;

FIG. 8 is a flow chart showing a method for selecting candidate genotypes according to a fourth embodiment of the present invention;

FIG. 9 is a flow chart showing a method for selecting candidate genotypes according to a fifth embodiment of the present invention; and

FIG. 10 is a block diagram showing a genome analyzing system according to another embodiment of the present invention.

### DETAILED DESCRIPTION OF PREFERRED EMBODIMENTS

Hereinafter, it will be described about an embodiment of the present invention in conjunction with the accompanying drawings to specifically describe to the extent that an ordinary skilled person in the technical field to which the present invention belongs could easily practice the technical scope of the present invention.

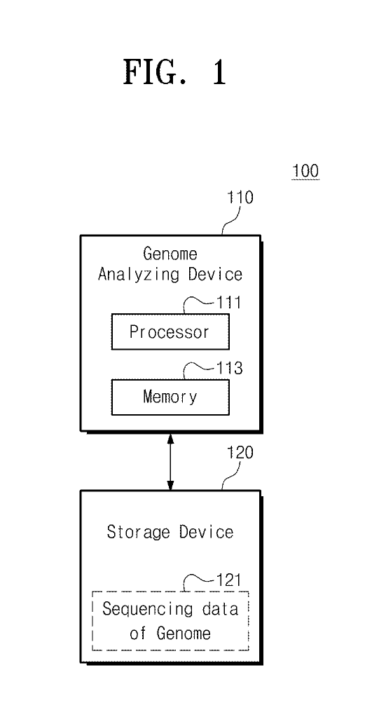

FIG. 1 is a block diagram showing a genome analyzing system 100 according to an embodiment of the present invention. Referring to FIG. 1, the genome analyzing system 100 includes a genome analyzing device 110 and a storage device 120.

The genome analyzing device 110 includes a processor 111 and a memory 113. The processor 111 may load a part of (or whole) sequencing data 121 of a genome stored in the storage device 120. The processor 111 may perform genomic analysis based on the sequencing data loaded on the memory 113. For instance, the processor 111 may identify genotypes at positions corresponding to the sequencing data loaded on the memory 113.

The processor 111 may identify genotypes by using quality values of bases and base types of the bases of the sequencing data loaded on the memory 113 instead of identifying genotypes based on the posteriori probability. By checking accuracy of the sequencing data 121 loaded on the memory 113 instead of reflecting a difference between a reference sequence and the sequencing data loaded on the memory 113, reliability of genotypes identified by the genome analyzing device 110 is improved. In addition, since there is no need for previously calculating likelihood which is used to calculate a posteriori probability, the genome analyzing device 110 does not perform an operation of loading the sequencing data 121 of the genome on the memory 113 for analyzing likelihood. Thus, the speed of the genome analyzing device 110 to analyze the genome is improved with respect to the typical genome analyzing device which calculates the likelihood.

Exemplary, the storage device 120 may be linked to the genome analyzing device 110 directly or through a network.

The genome analyzing device 110 may be a special purpose computer designed and manufactured to perform the method of analyzing a genome according to an embodiment of the present invention. The genome analyzing device 110 may be a special purpose computer designed and manufactured to derive an algorism or software which performs the method of analyzing a genome according to an embodiment of the present invention.

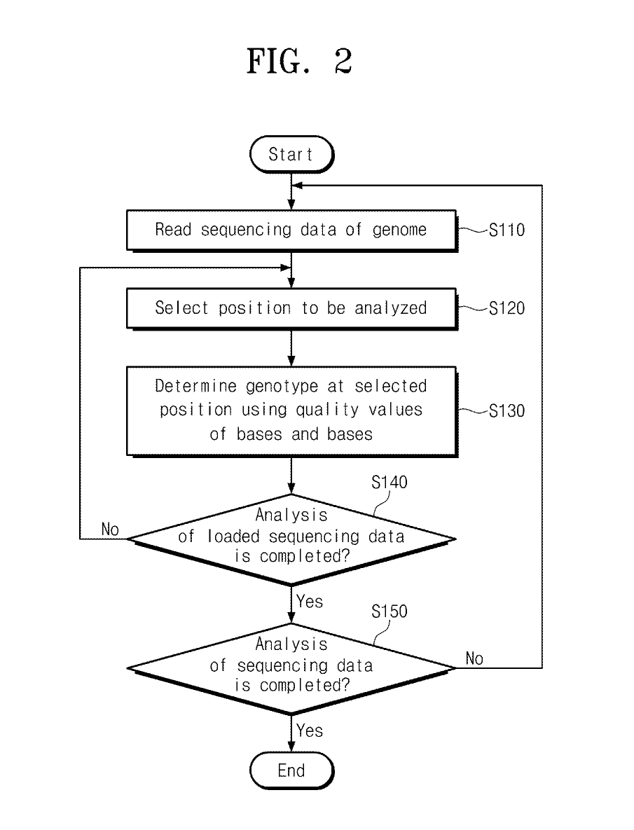

FIG. 2 is a flow chart showing a method of analyzing a genome according to an embodiment of the present invention. Referring to FIGS. 1 and 2, the genome analyzing device 110 may read a part of (or whole) sequencing data 121 of the genome from the storage device 120 in step S110. The read sequencing data may be loaded on the memory 113.

In step S120, the genome analyzing device 110 may select a position to be analyzed. Exemplary, the genome to be analyzed may include a plurality of positions where base types are arranged. The sequencing data loaded on the memory 113 may correspond to one or more positions. The genome analyzing device 110 may select one or more positions among positions corresponding to the sequencing data loaded on the memory 113 as a subject for analysis.

In step S130, the genome analyzing device 110 may determine a genotype at the selected position by using quality values of bases and the bases (e.g., base types of the bases) corresponding to the selected position among the sequencing data loaded on the memory 113.

For instance, sequencing data 121 of the genome is produced by amplifying (e.g., replicating) the genome to be analyzed and then dividing the amplified product into a plurality of fragments. Each fragment included in the amplified (or replicated) fragments is referred to as a base. Since amplification (or replication) is performed, a plurality of bases may correspond to a single position of the genome. Using quality values of the bases and the base types corresponding to the selected position, the genome analyzing device 110 may determine a genotype at the selected position.

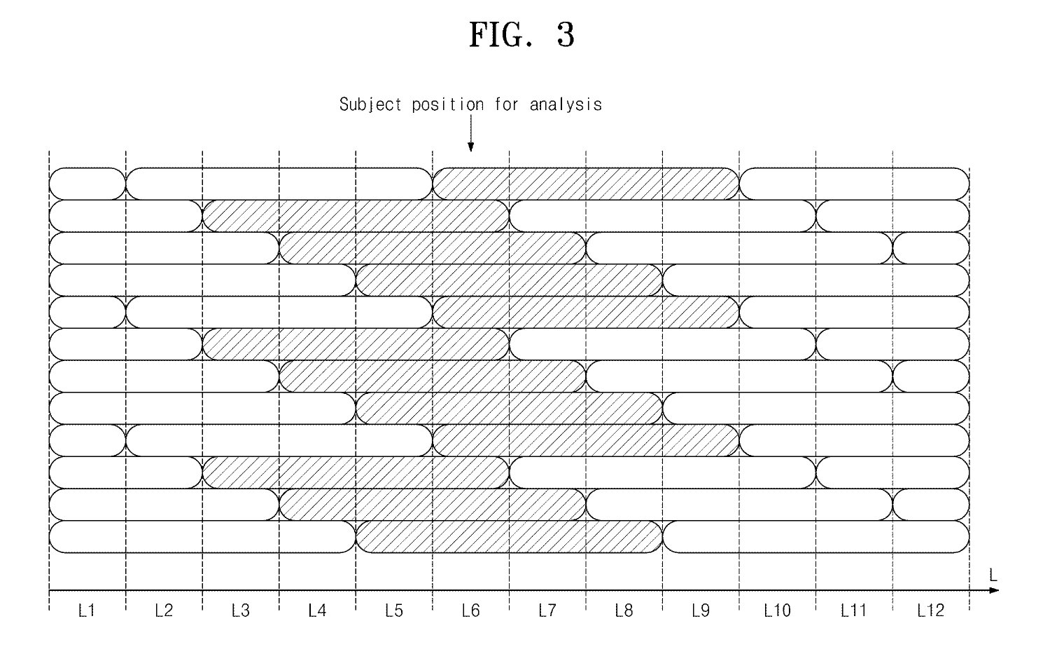

Exemplary, FIG. 3 depicts an example of bases corresponding to the selected position among sequencing data 121 of the genome loaded on the memory 113. In FIG. 3, the horizontal axis indicates a location of a genome L, and the vertical axis indicates bases.

Referring to FIGS. 1 to 3, sequencing data corresponding to a first position to a twelfth position (L1-L12) may be loaded on the memory 113. A sixth position (L6) may be selected as a subject for analysis among the first to the twelfth positions (L1 to L12). In FIG. 3, read sequences indicated by diagonal lines have bases corresponding to the sixth position (L6). Thus, a genotype at the sixth position (L6) is identified by using quality values and base types corresponding to the sixth position (L6) among base types of the lead sequences indicated by diagonal lines.

Referring to step S130 in FIG. 2 again, step S140 is performed after a genotype at the selected position is determined. In step S140, the genome analyzing device 110 identify whether analysis of genotypes at positions of sequencing data loaded on the memory 113 is completed or not. For instance, the genome analyzing device 110 may identify whether all of genotypes at the first position to the twelfth position (L1-L12) are determined or not.

If all of genotypes at positions of the sequencing data loaded on the memory 113 are not determined, in step S120, a position having an undetermined genotype is selected. Thereafter, a genotype at the selected position may be determined in step S130. After all genotypes at positions of the sequencing data loaded on the memory 113 are determined, step S150 is performed.

In step S150, the genome analyzing device 110 identify whether analysis of genotypes at positions of the sequencing data 121 of the genome stored in the storage device 120 is completed or not. For instance, the genome analyzing device 110 may identify whether all of genotypes at positions of sequencing data 121 of the genome are determined or not.

If analysis of the sequencing data 121 of the genome is not completed, sequencing data corresponding to positions having unidentified genotypes, among sequencing data 121 of the genome, are read in step S110. For instance, sequencing data may be loaded on the memory 113. Thereafter, genotypes at positions of the loaded sequencing data may be determined in steps S120 to S140.

After completing analysis of the sequencing data 121 of the genome, the genome analyzing device 110 may terminate analysis of the sequencing data 121 of the genome.

Exemplary, after completing analysis of the sequencing data 121 of the genome, the genome analyzing device 110 may further perform validation about determined genotypes. For instance, the genome analyzing device 110 may filter out a genotype determined for a position in which a score for determined genotypes (e.g., a probability-based score such as Phred score) is not greater than a threshold value.

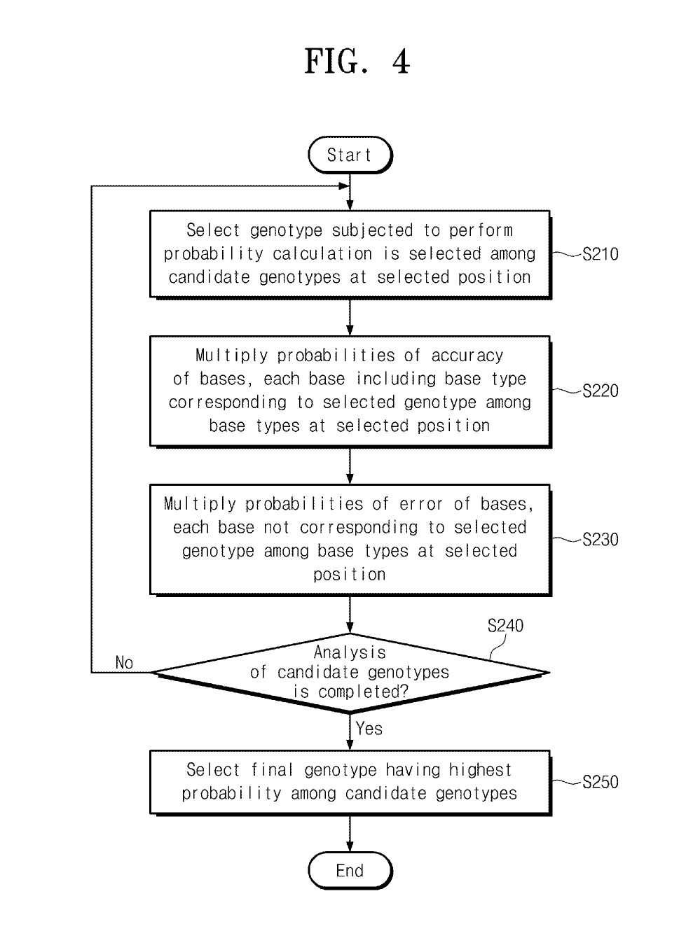

FIG. 4 is a flow chart showing an example of a method for determining a genotype at a selected position (step S130). Referring to FIG. 4, in step S210, a genotype, which will be subjected to perform probability calculation, is selected among candidate genotypes at the selected position. A genotype at the selected position may be one of combinations of two selected from adenine (A), guanine (G), cytosine (C), and thymine (T). For instance, the genotype at the selected position may be one among ‘AA’, ‘AG’, ‘AC’, ‘AT’, ‘GG’, ‘GC’, ‘GT’, ‘CC’, ‘CT’, and ‘TT’. A genotype, which will be subjected to perform probability calculation, may be selected among the aforementioned genotypes.

In step S220, probabilities of accuracy of bases are multiplied, wherein the bases includes a base type corresponding to the selected genotype among base types at the selected position. In step S230, probabilities of error of bases are multiplied, wherein the bases includes a base type which does not correspond to the selected genotype among base types at the selected position. The calculation result of step S220 may be multiplied by the calculation result of step S230.

Exemplary, hypothesizing that the selected genotype includes homogeneous base types, a probability of the selected genotype may be calculated according to Mathematical Formula 1.

P(XX)=[p(X₁^{A})·p(X₂^{A}) . . . p(Xₙ_{_{X}}_{(A)}^{A})]·[p(X₁^{C})·p(X₂^{C}) . . . p(Xₙ_{_{X}}_{(C)}^{C})]·[p(X₁^{G})·p(X₂^{G}) . . . p(Xₙ_{_{X}}_{(G)}^{G})][p(X₁^{T})·p(X₂^{T}) . . . p(Xₙ_{_{X}}_{(T)}^{T})] [Mathematical Formula 1]

In Mathematical Formula 1, P(XX) indicates a probability of a homogeneous genotype. X may be one among A, G, C, and T. n_{X(B)} indicates the number of bases which should have the base type X, but have the base type B among bases corresponding to the selected position. p(Xₖ^{B}) indicates a probability of a base corresponding to the selected position which is reflected for calculating a probability of the selected genotype. For instance, p(Xₖ^{B}) may be a probability of accuracy or a probability of error of a base having the base type B. B may be one among A, G, C, and T. p(Xₖ^{B}) may be defined as the Mathematical Formula 2.

$$p ( {X}_{k}^{B} ) = \{ \begin{matrix}1 - {P}_{k} , when B = X \\ \frac{{P}_{k}}{3} , when B \neq X\end{matrix} \qquad [ Mathematical Formula 2 ]$$

In Mathematical Formula 2, Pk indicates a probability of error of a base corresponding to the selected position. Pk is defined as Mathematical Formula 3.

$${P}_{k} = {10}^{- \frac{{Q}_{k}}{10}} \qquad [ Mathematical Formula 3 ]$$

In Mathematical Formula 3, Qₖ indicates a quality value of a base corresponding to the selected position, and may be, for example, Phred quality score. Exemplary, in the case where Qₖ is not Pred quality score, but other forms of a quality value, Mathematical Formula 3, which calculates a probability of error (Pₖ) from Qₖ, may be altered to other forms.

Exemplary, 50 bases may correspond to the selected position. Among 50 bases, it is possible that: 40 bases have the base type C; 5 bases have the base type G; 3 bases have the base type A, and 2 bases have the base type T. At the selected position, a probability of a homogeneous genotype having the base type CC, i.e., P(CC) may be calculated.

n_{C(A)} indicates the number of bases which should have the base type C but have the base type A. P(CC) indicates a probability in which all bases corresponding to the selected position have the base type C. Thus, it has been assumed that all base types of bases corresponding to the selected position should become C, when P(CC) is calculated. Among 50 bases, the number of bases having the base type A at the selected position may be n_{C(A)}. Namely, n_{C(A)} may be 3.

Likewise, n_{C(G)} indicates the number of bases having the base type C among 50 bases at the selected position, and may be 40. n_{C(G)} indicates the number of bases having the base type G among 50 bases at the selected position and may be 5. n_{C(T)} indicates the number of bases having the base type T among 50 bases at the selected position, and may be 2.

When calculating P(CC), X is C. Thus, Mathematical Formula 1 may be developed as Mathematical Formula 4.

P(CC)=[p(C₁^{A})·p(C₂^{A})·p(C₃^{A})]·[p(C₁^{C})·p(C₂^{C}) . . . p(C₄₀^{C})]·[p(C₁^{G})·p(C₂^{G}) . . . p(C₅^{G})]·[p(C₁^{T})·p(C₂^{T})] [Mathematical Formula 4]

In Mathematical Formula 4, a first square bracket indicates multiplication of probabilities of error of bases having the base type A at the selected position. A second square bracket indicates multiplication of probabilities of accuracy of bases having the base type C at the selected position. A third square bracket indicates probabilities of error of bases having the base type G at the selected position. A fourth square bracket indicates probabilities of error of bases having the base type T at the selected position.

When calculating P(CC), calculated is a probability in which all base types of bases of the selected position are C. By calculating a probability of accuracy of bases having the base type C corresponding to the selected genotype CC and probabilities of error of bases having the base type A, G or T which does not correspond to the selected genotype CC, a probability of the genome to have the genotype CC at the selected position is calculated.

A probability of other homogenous genotypes such as AA, GG, and TT may be calculated by the same method as described with reference to Mathematical Formula 4.

Exemplary, in the case where the selected genotype includes heterogeneous base types, a probability of the selected genotype may be calculated according to Mathematical Formula 5.

P(XY)=[p(X₁^{A})·p(X₂^{A}) . . . p(Xₙ_{_{X}}_{(A)}^{A})]·[p(X₁^{C})·p(X₂^{C}) . . . p(Xₙ_{_{X}}_{(C)}^{C})]·[p(X₁^{G})·p(X₂^{G}) . . . p(Xₙ_{_{X}}_{(G)}^{G})]·[p(X₁^{T})·p(X₂^{T}) . . . p(Xₙ_{_{X}}_{(T)}^{T})]·[p(Y₁^{A})·p(Y₂^{A}) . . . p(Yₙ_{_{Y}}_{(A)}^{A})]·[p(Y₁^{C})·p(Y₂^{C}) . . . p(Yₙ_{_{Y}}_{(C)}^{C})]·[p(Y₁^{G})·p(Y₂^{G}) . . . p(Yₙ_{_{Y}}_{(G)}^{G})]·[p(Y₁^{T})·p(Y₂^{T}) . . . p(Yₙ_{_{Y}}_{(T)}^{T})] [Mathematical Formula 5]

Exemplary, 50 bases may correspond to the selected position. Among 50 bases, it is possible that: 40 bases have the base type C; 5 bases have the base type G; 3 bases have the base type A, and 2 bases have the base type T. At the selected position, a probability of a homogeneous genotype having the base type CG, i.e., P (CG) may be calculated.

When a genotype at the selected position is CG, base types of bases at the selected position may be C or G. For instance, at the selected position, a ratio between C and G of base types of bases may be 1:1. For this case, 25 bases, among 50 bases, should have the base type C and remaining 25 bases should have the base type G.

However, base types of 40 bases, among 50 bases, are C. It is considered that 25 bases, among 40 bases having the base type C, are correct while 15 bases are miss-amplified (or miss-replicated). For instance, it is considered that 15 bases are error for the base type C even though they have the base type G according to hypothesis of a composition ratio of the base type of the genotype. Among 50 bases, since bases having the base type C exist as much as the described ratio, it is considered that bases having the base type A or T, which does not correspond to the genotype, should have the base type G; however, they become to have the base type A or T due to error during amplification (or replication).

n_{C(A)} indicates the number of bases which should have the base type C but have the base type A, and may be 0. n_{C(C)} indicates the number of bases which should have the base type C, but have the base type A, and may be 25. n_{C(G)} indicates the number of bases which should have the base type C, but have the base type G, and may be 0. n_{C(T)} indicates the number of bases which should have the base type C, but have the base type T, and may be 0.

n_{G(A)} indicates the number of bases which should have the base type G, but have the base type A, and may be 3. n_{G(C)} indicates the number of bases which should have the base type G, but have the base type C, and may be 15. n_{G(G)} indicates the number of bases which should have the base type G, and have the base type C, and may be 5. n_{G(T)} indicates the number of bases which should have the base type G, but have the base type T, and may be 2.

When calculating P(CG), X is C; and Y is G. Thus, Mathematical Formula 5 may be developed as Mathematical Formula 6.

P(CG)=[p(C₁^{C})·p(C₂^{C}) . . . p(C₂₅^{C})]·[p(G₁^{A})·p(G₂^{A})·p(G₃^{A})]·[p(G₁^{C})·p(G₂^{C}) . . . p(G₁₅^{C})]·[p(G₁^{G})·p(G₂^{G}) . . . p(G₅^{G})]·[p(G₁^{T})·p(G₂^{T})] [Mathematical Formula 6]

In Mathematical Formula 6, a first square bracket indicates multiplication of probabilities of accuracy of bases having the base type C at the selected position. A second square bracket indicates multiplication of probabilities of error of bases having the base type A at the selected position. A third square bracket indicates probabilities of error of bases having the base type C at the selected position. A fourth square bracket indicates probabilities of accuracy of bases having the base type G at the selected position. A fifth square bracket indicates probabilities of error of bases having the base type T at the selected position.

When calculating P(CG), among bases having the base type C, a probability of accuracy of first bases is calculated and a probability of error of second bases is calculated. Exemplary, among bases having the base type C, a first base may be selected in an order of the highest probability of accuracy (or quality value) or of the lowest probability of error. Exemplary, among bases having the base type C, a second base may be selected in an order of the lowest probability of accuracy (or quality value) or of the highest probability of error.

To sum up, a probability of a homogeneous genotype may be calculated at a selected position. In this case, a probability of a genotype may be calculated as a result of multiplying probabilities of error of bases having a base type differing from a base type of the homogenous genotype and probabilities of accuracy of bases having the same base type as the base type of the homogeneous genotype at the selected position, among bases corresponding to the selected position.

Further, a probability of a heterogeneous genotype may be calculated at a selected position. According to the predetermined ratio, the number of bases may be divided into a first value, and a second value. For instance, the first value may be allocated to a first base type, and the second value may be allocated to a second base type of the heterogeneous genotype.

As a first example, at the selected position, the number of bases having the first base type may not be greater than the first value, and the number of bases having the second base type may not be greater than the second value. In this case, a probability of the genotype may be calculated as a result of multiplying probabilities of accuracy of bases having the first base type, and probabilities of accuracy of bases having the second base type by probabilities of error of remaining bases which do not have the first and the second base types.

As a second example, at the selected position, the number of bases having the first base type may be greater than the first value, and the number of bases having the second base type may be less than the second value. In this case, a probability of the genotype may be calculated as a result of multiplying probabilities of accuracy of the first bases corresponding to the first value among bases having the first base type, probabilities of error of the remaining second bases among bases having the first base type, probabilities of accuracy of bases having the second base type, and probabilities of error of remaining bases which do not have the first and second base types. The first bases may be selected as bases having relatively higher probabilities of accuracy or lower probabilities of error among bases having the first base type. The second bases may be selected as bases having relatively lower probabilities of accuracy or higher probabilities of error among bases having the first base type.

Exemplary, although a ratio of dividing the number of bases into the first value and the second value has a default value, the ratio be adjusted. For instance, the ratio has the default value of 1:1. Depending on quality values of bases, the ratio may be adjusted. For instance, the ratio may be adjusted to 1.5:0.5 without limitation.

Referring to FIG. 4 again, step S240 is performed after step S220 and step S230 are performed. In step S240, it is identified whether analysis of candidate genotypes is completed or not. For instance, it may be identified that probabilities of all candidate genotypes are calculated or not. If analysis of candidate genotypes is not completed, in step S210, a candidate genotype having an uncalculated probability is selected, and a probability of the selected genotype is calculated in step S220 and step S230. If analysis of candidate genotypes is completed, step S250 is performed.

In step S250, a genotype having the highest probability among the analyzed candidate genotypes is selected as a final base type

According to the described embodiment, the genotype of the selected position is identified by using base types and quality values of bases of sequencing data to be analyzed without using a reference sequence.

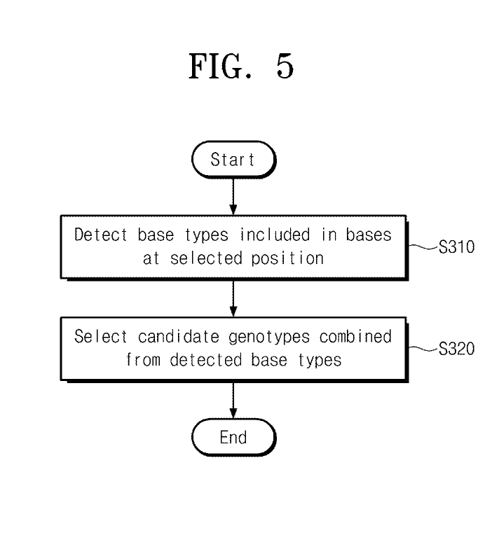

FIG. 5 is a flow chart showing a method for selecting candidate genotypes according to a first embodiment of the present invention. Referring to FIG. 5, in step S310, base types included in bases is detected at a selected position. In step S320, genotypes combined from the detected base types are selected as candidate genotypes.

For instance, base types of bases at the selected position may include A, C and G, and exclude T. In this case, genotypes combined by A, C, and G are selected as candidate genotypes and a genotype including T does not selected as a candidate genotype. Consequently, the number of candidate genotypes for performing probability calculation is reduced, and therefore the speed of genome analysis according to one embodiment of the present invention is more improved.

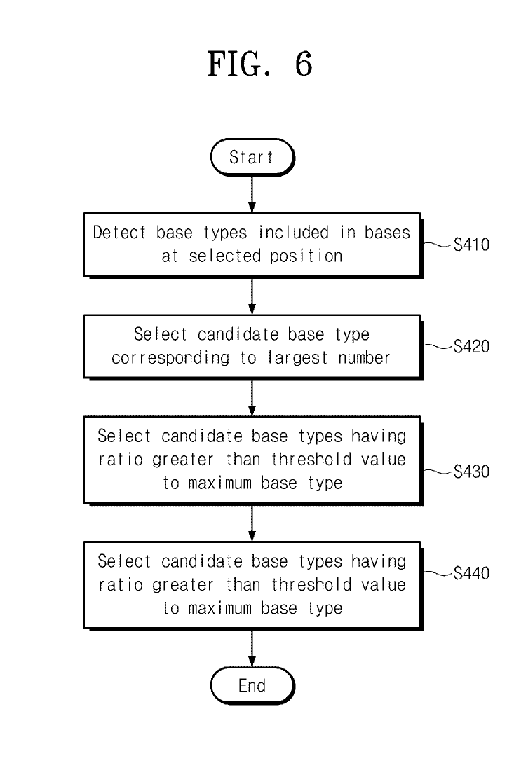

FIG. 6 is a flow chart showing a method for selecting candidate genotypes according to a second embodiment of the present invention. Referring to FIG. 6, in step S410, base types included in bases are detected at a selected position.

In step S420, a maximum base type is selected as a candidate base type, wherein the maximum base type corresponds to the largest number of bases among detected base types.

In step S430, a base type, which has bases having a ratio equal to or greater than a threshold value with respect to the number of bases of the maximum base type, is selected as a candidate base type.

In step S440, genotypes combined from the candidate base types are selected as candidate genotypes.

For instance, among 50 bases, it is possible that: 20 bases have the base type A; 15 bases have the base type C; 10 bases have the base type G; and 5 bases have the base type T. The threshold value may be 0.5.

The base type A, which corresponds to the largest number of bases, is selected as a candidate base type. The ratio of the number of bases of the base type C, i.e., 15, to the number bases of the maximum base type, i.e., 20, is 15/20, which is equal to or greater than the threshold value. Thus, the base type C may be selected as a candidate base type. The ratio of the number of bases of the base type G, i.e., 10, to the number bases of the maximum base type, i.e., 20, is 10/20, which is equal to or greater than the threshold value. Thus, the base type G may be selected as a candidate base type. The ratio of the number of bases of the base type T, i.e., 5, to the number bases of the maximum base type, i.e., 20, and is 5/20, which is smaller than the threshold value. Thus, the base type T does not selected as a candidate base type.

In this case, genotypes combined by A, C, and G, which are selected as candidate base types, are selected as candidate genotypes and a genotype including T, which is not a candidate base type, does not selected as a candidate genotype.

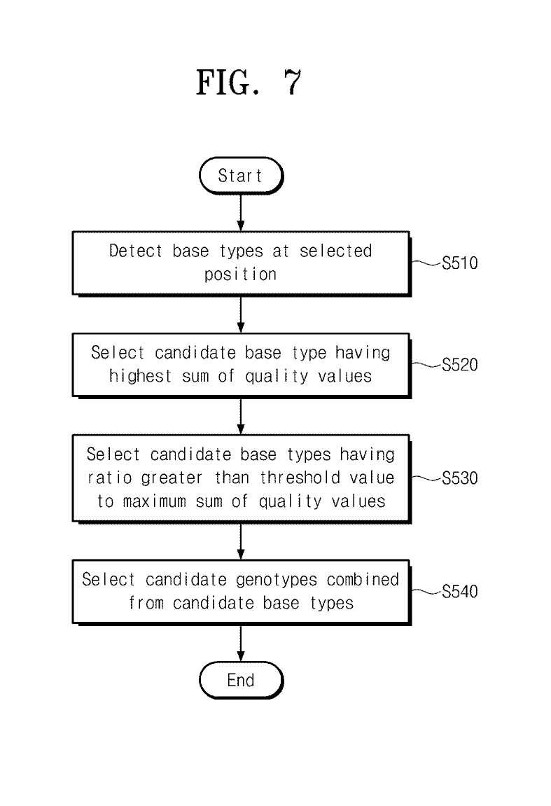

FIG. 7 is a flow chart showing a method for selecting candidate genotypes according to a third embodiment of the present invention. Referring to FIG. 7, in step S510, at a selected position, base types included in bases is detected.

In step S520, a base type having the highest sum of quality values among the detected base types is selected as a candidate base type.

In step S530, a base type, which has a base type having a ratio of a sum of quality values equal to or greater than a threshold value with respect to the sum of quality values of the first candidate base type, may be selected as a candidate base type.

In step S440, genotypes combined from the candidate base types are selected as candidate genotypes.

For instance, among bases corresponding to the selected position, a sum of quality values of bases having the base type A may be 200. A sum of quality values of bases having the base type C may be 150. A sum of quality values of bases having the base type G may be 100. A sum of quality values of bases having the base type T may be 50. The threshold value may be 0.5.

The base type A, which has the highest sum of quality values, is selected as a first candidate base type. A ratio between the sum of quality values of the first candidate base type, 200, and the sum of quality values of bases of the base type C, 150, is 150/200, which is equal to or greater than the threshold value. Thus, the base type C may be selected as a candidate base type. A ratio between the sum of quality values of the first candidate base type, 200, and the sum of quality values of bases of the base type G, 100, is 100/200, which is equal to or greater than the threshold value. Thus, the base type G may be selected as a candidate base type. A ratio between the sum of quality values of the first candidate base type, 200, and the sum of quality values of bases of the base type T, 50, is 50/200, which is less than the threshold value. Thus, the base type T does not selected as a candidate base type.

Genotypes combined by A, C, and G, which are selected as candidate base types, are selected as candidate genotypes, and a genotype including T, which is not a candidate base type, does not selected as a candidate genotype.

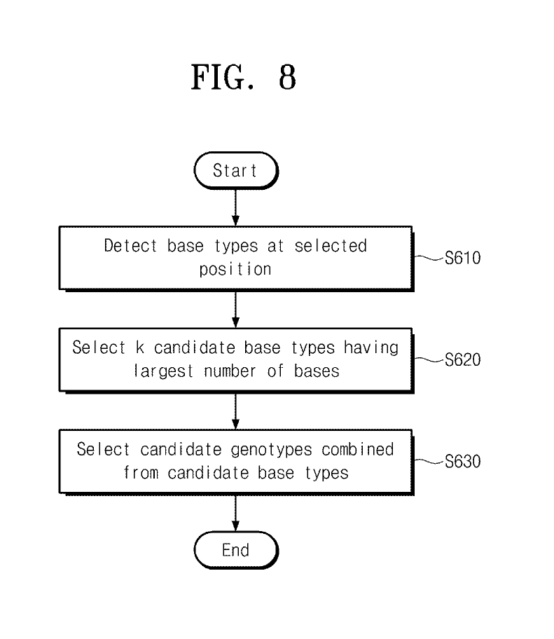

FIG. 8 is a flow chart showing a method for selecting candidate genotypes according to a fourth embodiment of the present invention. Referring to FIG. 8, in step S610, base types included in bases are detected at a selected position.

In step S620, ‘k’ number of base types, which have the largest number of bases among detected base types, are selected as candidate base types.

In step S630, genotypes combined from the candidate base types are selected as candidate genotypes.

For instance, at the selected position, it is possible that: the number of bases having the base type A is 20; the number of bases having the base type C is 15; the number of bases having the base type G is 10; and the number of bases having the base type T is 5. K may be 2.

In this case, two base types having largest bases, i.e., the base types A and C, are selected as candidate base types. Genotypes combined by A, and C, which are selected as candidate base types, are selected as candidate genotypes, and genotypes including the base type G or T, which does not selected as a candidate base type, do not selected as candidate genotypes.

K is assumed to be 2, but not limited thereto. Further, in the case where the number of base types of bases at the selected position is less than k, all base types of bases at the selected position may be selected as candidate genotypes.

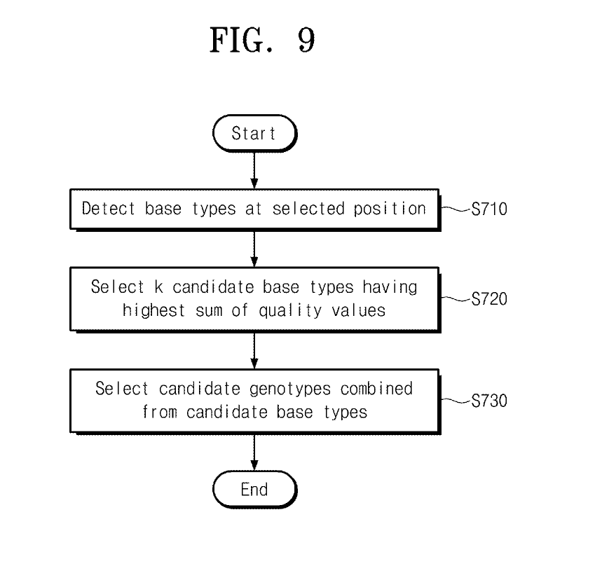

FIG. 9 is a flow chart showing a method for selecting candidate genotypes according to a fifth embodiment of the present invention. Referring to FIG. 9, in step S710, base types included in bases are detected at a selected position.

In step S720, ‘k’ number of base types, which have the highest sum of quality values of bases among detected base types, are selected as candidate base types.

In step S630, genotypes combined from the candidate base types are selected as candidate genotypes.

For instance, at the selected position, it is possible that: a sum of quality values of bases having the base type A is 200; a sum of quality values of bases having the base type C is 150; a sum of quality values of bases having the base type G is 100; and a sum of quality values of bases having the base type T is 50. K may be 2.

In this case, two base types having the highest sum of quality values, i.e., the base types A and C, are selected as candidate base types. Genotypes combined by A, and C, which are selected as candidate base types, are selected as candidate genotypes, and a genotype including the base type G or T, which does not selected as a candidate base type, does not selected as a candidate genotype.

K is assumed to be 2, but not limited thereto. Further, in the case where the number of base types of bases at the selected position is less than k, all base types of bases at the selected position may be selected as candidate genotypes.

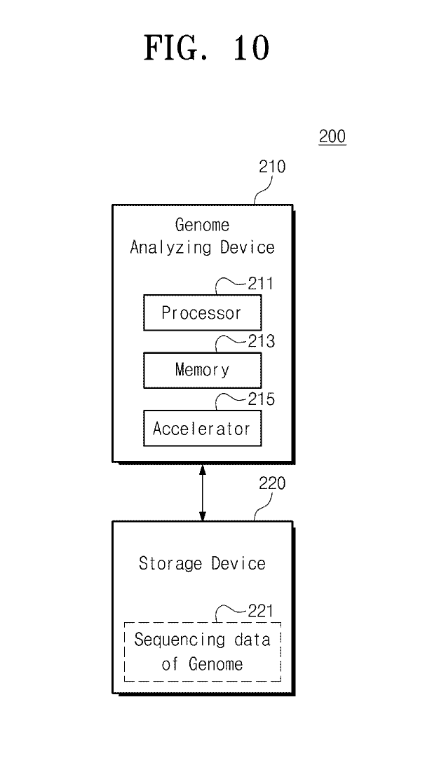

FIG. 10 is a block diagram showing a genome analyzing system 200 according to another embodiment of the present invention. Referring to FIG. 10, the genome analyzing system 200 includes a genome analyzing device 210 and a storage device 220. The genome analyzing device 210 includes a processor 211, a memory 213, and an accelerator 215. The storage device 220 is configured to store sequencing data 221 of a genome.

Comparing to the genome analyzing system 100 in FIG. 1, the genome analyzing device 210 of the genome analyzing system 200 further includes the accelerator 215. The accelerator 215 may be a hardware configured to perform predetermined calculation at high speed. The processor 211 may share and perform analysis of sequencing data with the accelerator 215.

Exemplary, the accelerator 215 may perform calculation of a probability of a selected genotype at a selected position. The accelerator 215 may perform an operation of determining bases which correspond to a position of respective genome.

The processor 211 may perform an operation of reading sequencing data 211 of the genome from the storage device 210, and then forming a structure which is treatable in the genome analyzing device 210 in a multi-threading manner.

According to examples of the present invention, a genotype is identified based on base types and quality values of bases of a genome to be analyzed. Thus, accuracy of genome analysis is improved. Further, according to examples of the present invention, there is no operation of previously reading sequencing data for likelihood calculation. Thus, the calculation speed of genome analysis is improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for analyzing a genome by a genome analyzing device, the method comprising:
reading, by the genome analyzing device, sequencing data of a genome from a storage device;
selecting, by the genome analyzing device, a position to be analyzed among positions of the genome corresponding to the sequencing data;
determining, by the genome analyzing device, a genotype at the selected position by using quality values and base types of bases corresponding to the selected position among the sequencing data,
wherein the determining of the genotype at the selected position comprises:
calculating, by the genome analyzing device, probabilities of accuracy and probabilities of error of the base types of the bases corresponding to the selected position, by using the quality values;
selecting a genotype which will be subjected to perform probability calculation among candidate genotypes at the selected position; and
calculating a probability of the selected genotype by using probabilities of accuracy of bases having base types corresponding to the selected genotype and probabilities of error of bases having base types which do not correspond to the selected genotype, among base types of the bases corresponding to the selected position;
wherein the calculating of the probability of the selected genotype comprises:
when the selected genotype is a homogenous genotype, multiplying probabilities of accuracy of bases corresponding to the base type of the selected genotype by probabilities of error of bases which do not correspond to base types of the selected genotype among the bases of the selected position; and
when the selected genotype is a heterogeneous genotype, determining a ratio between a first base type and a second base type of the selected genotype, selecting first bases corresponding to the first base type and second bases corresponding to the second base type among the bases at the selected position according to the determined ratio, and multiplying probabilities of accuracy of the selected first and second bases by probabilities of error of unselected bases.

2. The method of claim 1, wherein the selecting of the first bases corresponding to the first base type and the second bases corresponding to the second base type among the bases at the selected position according to the determined ratio comprises:
dividing the number of bases corresponding to the selected position into a first value and a second value according to the determined ratio;
selecting, as the first bases, bases corresponding to the first base type when the number of bases corresponding to the first base type is not greater than the first value, and selecting, as the first bases, bases as much as the first value among bases corresponding to the first base type when the number of bases corresponding to the first base type is more than the first value; and
selecting, as the second bases, bases corresponding to the second base type when the number of bases corresponding to the second base type is not greater than the second value, and selecting, as the second bases, bases as much as the second value among bases corresponding to the second base type when the number of bases corresponding to the second base type is greater than the second value.

3. The method of claim 2, wherein when the number of the first bases is greater than the first value, bases having a relatively high quality value are selected as the first bases.

4. The method of claim 1, wherein the ratio is adjusted.

5. The method of claim 1, wherein the selecting of the genotype and the calculating of the probability of the selected genotype are repetitively performed until the whole candidate genotypes are selected once.

6. The method of claim 5, wherein the determining of the genotype of the selected position further comprises selecting a candidate genotype having the highest probability among the candidate genotypes as a genotype of the selected position.

7. The method of claim 1, wherein the determining of the genotype of the selected position further comprises selecting the candidate genotypes.

8. The method of claim 7, wherein the determining of the candidate genotypes comprises:
detecting base types of the bases at the selected position; and
selecting, as the candidate genotypes, genotypes combined by the detected base types.

9. The method of claim 7, wherein the selecting of the candidate genotypes comprises:
detecting base types of the bases at the selected position;
selecting, as a first candidate base type, a maximum base type corresponding to the largest number of bases among the detected bases at the selected position;
selecting, as a second candidate base type, a base type having the number of bases having a ratio equal to or greater than a threshold value with respect to the number of bases of the maximum base type at the selected position; and
selecting, as the candidate genotypes, genotypes combined by the first candidate base type and the second candidate base type.

10. The method of claim 7, wherein the selecting of the candidate genotypes comprises:
detecting base types of the bases at the selected position;
selecting, as a first candidate base type, a base type in which a sum of quality values of bases is the highest among the detected base types at the selected position;
selecting, as a second candidate base type, a base type in which a sum of quality values has a ratio equal to or greater than a threshold value with respect to the sum of total quality values of the first candidate base type at the selected position; and
selecting, as the candidate genotype, genotypes combined by the first candidate base type and the second candidate base type.

11. The method of claim 7, wherein the selecting of the candidate genotypes comprises:
detecting base types of the bases at the selected position;
selecting at least one base type in an order of the highest number of bases among the detected base types at the selected position; and
selecting, as the candidate genotypes, genotypes combined by the at least one base type selected.

12. The method of claim 7, wherein the selecting of the candidate genotypes comprises:
detecting base types of the bases at the selected position;
selecting at least one base type in an order of the highest sum of quality values of bases among the detected base types at the selected position; and
selecting, as the candidate genotypes, genotypes combined by the at least one base type selected.

13. The method of claim 1, wherein the selecting of the position and the determining of the genotype of the selected position are repetitively performed until genotypes at all positions of the genome corresponding to the sequencing data are determined.

14. The method of claim 1, wherein the reading of the sequencing data comprises reading sequencing data corresponding to one or more positions of the genome.
